(19) United States
(12) Patent Application Publication
(10) Pub. No.: US 2014/0258828 A1
(43) Pub. Date: Sep. 11, 2014

(54) PICK-AND-PLACE WEBFORM AUTOFILL

(71) Applicants: Brent Lymer, Las Vegas, NV (US); Juan Games, Foster City, CA (US); Thankasala Prasanna, Sunnyvale, CA (US)

(72) Inventors: Brent Lymer, Las Vegas, NV (US); Juan Games, Foster City, CA (US); Thankasala Prasanna, Sunnyvale, CA (US)

(21) Appl. No.: 13/792,249

(22) Filed: Mar. 11, 2013

(51) Int. Cl. G06F 17/24

(52) U.S. Cl. CPC G06F 17/243
USPC 715/224

(57) ABSTRACT

An autofill browser extension or smartphone app provides for the secure storage and autofill populating of webforms with personal user information. A popup menu of stored answers appears in front of or next to a form requesting a user to fill it out. The user selects the right answer to each question and simply drags and drops it, or picks and places it in the corresponding spot in the webform. If the answer needs to be a new one, the user clicks on the box for it in the webform, enters the answer. In alternative embodiments that answer can be automatically added to the menu. Autofill database maintenance is easy and intuitive. A template describing the construction and URL location of the webform is automatically registered with a server and that enables a community of users to share in quicker, easier, form fills.

### RELATED APPLICATION

This Application claims benefit of Provisional U.S. Patent Application, Ser. No. 61/726,678, filed Nov. 15, 2012. Such Application is incorporated herein by reference.

### BACKGROUND OF THE INVENTION

1. Field of the Invention

The present invention relates to webform autofill programs for online transactions, and more particularly to utility apps in smartphones that allow users to pick-and-place credit card storage and autofill data into order forms from encrypted data they've stored previously.

2. Description of Related Art

Google's Chrome Web browser is equipped with an autofill function to help users quickly type in form data. It is meant to be a time-saving feature, but it often becomes an obstruction when it fills in the wrong information. Or the right information in the wrong places.

Then, not only does the originally requested data still need to be entered, but the erroneous data supplied by the autofill program needs to be removed. These kinds of autofill programs store users' home addresses, social security numbers, credit card numbers, and other sensitive personal information that needs to be protected. Many users do not trust their autofill programs, especially when it makes so many mistakes, so they remove their data so it can't be abused or compromised, and the automatic autofill function disabled.

Several Chrome Extensions have already been developed and offered by various people to solve some of the shortcomings mentioned. These free extensions include AUTOFILL, CHROME-AUTOFILL-ENHANCER, OPENID AUTOFILL, SIMPLE FORM FILLER, JUNKFILL, AUTOFILL ABUSE PROTECTION, FORMFILLER, MAGIC INPUTS FILLER, FORM BUILDER, and many others. Each of which has its own unique way of operating, and each of which has its own failings.

RoboForm is one of the most successful and widely used autofill applications, see http://www.roboform.com/how-it-works/overview. It provides secure password storage and synchronization. It has versions available for all the popular browsers and mobile devices.

It seems that most of these conventional autofill extensions require a lot of typing, editing, and maintenance. And the security of the information that they store is very iffy. One Google user criticized Chrome-Autofill-Enhancer saying it needs an option to change default hotkey; to insert content, not replacing everything has already typed; to insert content everywhere like on Yahoo, Gmail, etc.; and, to encrypt the content stored in its database for sensitive information. Another user said it does not work for JavaScript form elements, making it worthless. It can't use on anything Google related to popup forms, etc. They suggested a listen function where you could type in a string, “text1”, and have it enter as prearranged information.

Another more insightful user suggested, “It would be also great to have a possibility to make different autofill lists to be available for different sites.”

The small touchscreens common today on smartphones and tablets make the entering of form information especially challenging through their tiny soft keyboards. An autofill app that works right and really secures personally identifiable information would be well received by the world community.

The OMB memorandum defines PII as information which can be used to distinguish or trace an individual's identity, such as their name, social security number, biometric records, etc. alone, or when combined with other personal or identifying information which is linked or linkable to a specific individual, such as date and place of birth, mother's maiden name, etc.

### SUMMARY OF THE INVENTION

Briefly, an autofill extension embodiment of the present invention provides a user metaphor for the secure storage and autofill populating of webforms with personal user information. A popup menu of stored answers appears in front of or next to a form requesting a user to fill it out. The user selects the right answer to each question and simply drags and drops it, or picks and places it in the corresponding spot in the webform. If the answer needs to be a new one, the user clicks on the box for it in the webform, enters the answer with a soft keyboard. A template describing the construction and URL location of the webform mapping is automatically registered locally, or with a server that enables a community of users to share in quicker, easier, form fills.

The above and still further objects, features, and advantages of the present invention will become apparent upon consideration of the following detailed description of specific embodiments thereof, especially when taken in conjunction with the accompanying drawings.

### BRIEF DESCRIPTION OF THE DRAWINGS

FIG. 1 is a functional block diagram of autofill system embodiment of the present invention embodied in a mobile smartphone;

FIG. 2 is a process flow diagram of a graphical user interface (GUI) method for operating in a mobile device (FIG. 1) with a touchscreen for pointing and data entry;

FIG. 3 is a process flow diagram of a pick-and-place autofill method embodiment of the present invention which is similar to that of FIG. 2. But here, the answers are automatically sequenced in a menu and the answers are dropped into the webform by screen tapping the corresponding question;

FIG. 4 is a process flow diagram of a pick-and-place autofill method embodiment of the present invention which is the conventional laptop equivalent of that of FIG. 2. Here, mouse pointing and clicking is used to drop the answers from an automatically sequenced menu into a webform; and

FIGS. 5A-5E are screenshot diagrams of part of the action described for the pick-and-place autofill method of FIG. 3.

### DETAILED DESCRIPTION OF THE INVENTION

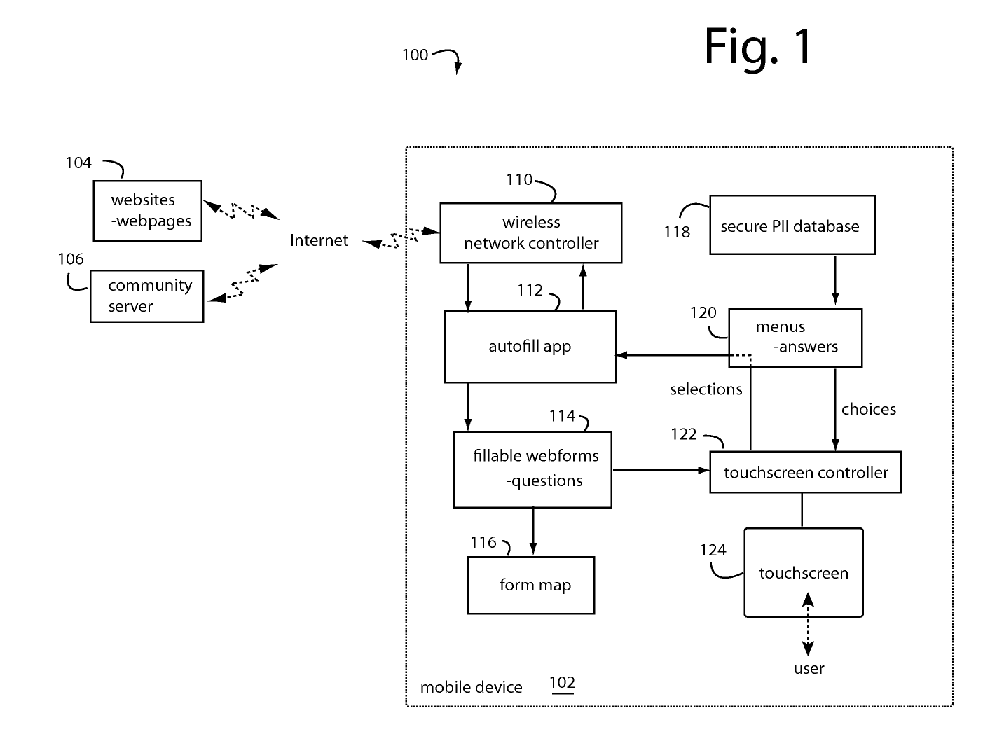

FIG. 1 represents an autofill system embodiment of the present invention, and is referred to herein by the general reference numeral 100. Autofill system 100 is always hosted on a mobile device 102 that can access webpages from websites 104 over a wireless network and the Internet. A community server 106 may be provided to collect and distribute intelligence about how users have been filling out webforms on webpages on websites 104 with their mobile devices 102.

A wireless network controller 110 provides wireless Internet access and can include conventional support like a smartphone and its operating system. An autofill app 112 can be downloaded and installed on the mobile device using a mobile app store such as Apple or Android. A number of fillable webforms 114 with questions to answer have their constructions abstracted as a form map 116. A secure personally identifiable information (PII) database 118 stores and controls access to data input and managed by a user. Such PII includes information ordinarily needed repetitively by a user to complete a checkout procedure with a shopping cart at an online webstore or a bank.

A number of menus 120 are organized into sets of answers from data obtained from the PII database 118 or realtime touchscreen inputs from a user. A touchscreen controller 122 simultaneously presents the fillable webforms 114 and a selected menu 120 and its answer lists on a touchscreen 124.

In a credit card (CC) mode, a user selects an icon for a particular credit card they want to use on a website checkout screen they're visiting. A popup menu appears for the corresponding credit card with a list of the information answers and responses that it associates, e.g., CC number, expiry date, CVV, account name, address, phone number. These appear in a linear list with one item highlighted. The user identifies which field or box in the form should get the highlighted answer, and clicks on it. That box autofills and the CC menu highlight advances to the next item. The user identifies which box in the form should get the second highlighted answer, and clicks on it. That second box autofills and the CC menu highlight advances to the third item, and so on until the form is filled.

Other transfer modes are also possible, e.g., drag-and-drop, pick-and-place. In drag-and-drop the user drags the answer in the menu over to the form and drops it in the corresponding box. In pick-and-place, the user touches or taps the answer to use in the menu, then touches or taps where to drop it in the form. The selected answer gets highlighted when it is “picked”.

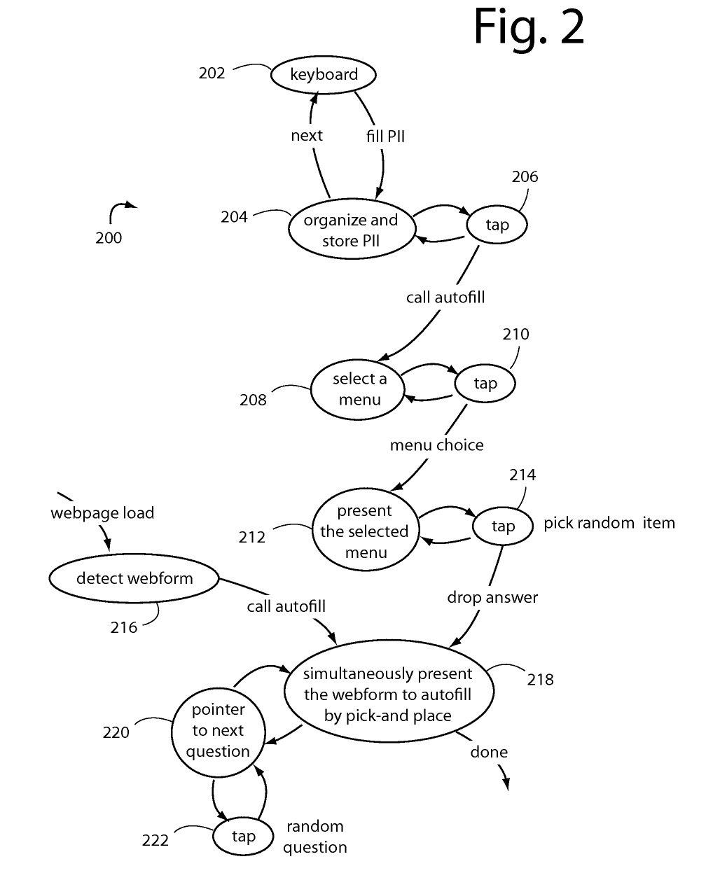

FIG. 2 represents a graphical user interface (GUI) method for operating in a mobile device 102 (FIG. 1) with a touchscreen 124 for pointing and data entry, and is referred to herein by the general reference numeral 200. A soft keyboard 202 can be called at any time onto the touchscreen 124 to enter or overwrite lists of items in menus maintained by a process 204 for organizing and storing PII. A screen tap 206 will call a process 208 for user selection of a menu. A screen tap 210 selects which menu to use, and a process 212 presents the menu and its items list for the user to consider. A screen tap 214 allows the user to pick any menu item by random.

Simultaneously, webpages loaded by the mobile device 102 are screened by a process 216 to detect if a webform is present that needs autofill assistance. Such would occur when the user navigates to a shopping cart checkout. If so, a pick-and-place process 218 displays the webform simultaneously with the menu selected by process 208. A screen tap 214 will drop an answer picked at random from a list of items in the selected menu into a question box or form field in the webform pointed to by a process 220. Once answered or otherwise responded to, process 220 will advance the visual indicator and select a next item in a menu list. The user can then tap on a field in the webform to fill it with the data from the selected/highlighted menu list item. Alternatively, it can advance a highlight, cursor, pointer, or other kind of visual indicator to a next form field needing a response. A screen tap 222 can jump at random to point to any form field tapped or touched by the user.

The organize and store PII process 204 can track the class of menu items that the user indicates should go in particular form fields in the webform. The webforms encountered in real life have no consistency in their field naming conventions. For example, the first and last name of a user could be required by a form field, and identified in the form as “name”, or “first” and “last”, or “first name” and “last name”, “FN” and “LN”, etc. Expiry dates, abbreviated state names, and other items can be embodied in drop down lists.

In alternative embodiments, the organize and store PII process 204 generates its own naming standards that it consistently applies across-the-board to any form field encountered on any webpage and webform from any website. It keeps XPath or other descriptors that can help it uniquely identify html elements in a webform. The predictive auto-filling attachment and application of menu list items must be accurate, and therefore uses a combination of (a) JavaScript, (b) listening for specific events on elements of interest, (c) querying the HTML DOM object, (d) exchanging data with the mobile app native code, and (e) uniquely associating XPath data with site url and at the same time PII custom data types (not the data themselves).

The form field labels, names, classes, and types are managed such that auto-filling proceed without significant errors or annoyances to the user the next time the webform is loaded and requiring a response.

In instances where a community of users exist, the uniformity is maintained across the community. However, no PII is shared or transmitted for the community purpose.

A graphical user interface (GUI) method for operating in a mobile device 102 (FIG. 1) with a touchscreen 124 for pointing and data entry includes organizing and storing PII configured to be presented as a series of selectable menus 120 by touching an icon on a user touchscreen 124 into a memory 118 in the mobile device 102.

Webforms are such that the fields to be filled in do not have to be in any specific order. A cursor may not need to be automatically advanced to a next question. An auto-advance can be built into in a PII menu list preparing the user to tap and fill the appropriate field in the webform. Early implementations did not recycle back to the beginning in the webform. In the PII menu lists, is not necessary to recycle and highlight the first item after the last item is reached.

In alternative embodiments, a menu is selected and presented to permit a choice of touchable menu items configured to be answers to questions calculated to be posed by a fillable webform 114. A current fillable webform is simultaneously displayed with a cursor, highlight, or other indication of a current question to be responded to by the user. Any touch or tap on the fillable webform 114 will advance the current question to a question displayed under the point touched or tapped. Any touch or tap on the selected menu is interpreted as a reply to the current question with an answer displayed under such. The current question is advanced to a question not yet answered, or a pointer cycles back around to the beginning of the questions in the fillable webform 114. Answers from the menus 120 are thereby caused to populate fields one-by-one in the fillable webform 114 strictly according to the current question being posed and a user selection of a menu item by touch or tap. At least in a first encounter with the particular fillable webform 114.

The PII is secured in an encrypted memory vault (e.g., secure PII database 118) within a non-volatile memory in the mobile device 102. Not all applications will involve PII, the convenience of use would be enough to compel use of various embodiments of the present invention.

At least one security factor, such as a password or a fingerprint, is needed from the user to allow access to the PII and its subsequent display in a touchscreen menu. Requiring at least two security factors would provide strong authentication, e.g., what-you-know, what-you-have, who-you-are, where-you-are, what-time-it-is, what-you're-buying, etc.

The organization and questions posed by fillable webforms are identified and logged into a database or form map 116, such that predictive answers to more-or-less standard questions are thereafter made possible. Which questions appear in what locations in each the fillable webforms 114 are mapped to enable automatic predictive answering if allowed by the user. A check is made to see if a current fillable webform 114 being presented anew is one that has been previously identified, logged, and mapped. Such check involves consulting either form map 116, or community server 106, or both. If so, answers provided as local menu items are used to automatically and predicatively populate the fillable webform. A populated fillable webform results, and is made available for user correction and approval by touch or tap.

In another embodiment of the present invention, the organization and questions posed by the fillable webforms are identified and logged. A map is constructed to memorialize which questions appear in what locations in each the fillable webform to enable automatic predictive answering. However, that can change as webforms are updated.

The identities, logs, and mappings, and without any PII, are forwarded to a server database in community server 106 such that near-perfect predictive answers are subsequently made possible across a community of users. Other mobile devices 102 in such community are configured to check if a current fillable webform they are being presented with anew is one that has been previously identified, logged, and mapped into the server database 106 by someone else. If so, the classes, labels, types, and names associated with the answers provided in each of their local menu items are used to privately, automatically, and predicatively populate the fillable webform. A populated fillable webform that results that can be displayed for the corresponding user to correct and approve by touch or tap.

In any event, a first-time data entry of PII by a user can be done through the touchscreen 124 into memory 118 in mobile device 102. A password is also configured to control access to the PII in memory 118 by the menus 120.

Some fillable webforms are difficult for autofill apps to recognize, interpret, manipulate, fill out, detect form fields, or otherwise respond to. Those forms resulting from JavaScript executions, select fields, drop down lists, other popups, and radio-buttons are choices that are typically implemented and presented in non-standard ways by web sites and these are challenging to accurate predictive auto-filling. Some form fields that need to be recognized and answered can comprise unidentified boxes inside tables inside frames, all within an html written by a third party.

Embodiments of the present invention nevertheless find and identify the form fields that must be answered in typical credit card checkout procedures for conventional shopping cart metaphors and user experiences. Each user assists in such by tapping on an answer and then tapping on a box having a question to answer. The tap on the question box reveals the paths that need to be remembered for predictive automatic form filling. A separate log can be maintained locally, or on a community server 106 using data cleaned of PII but still identifying forms and fields with consistent names, labels, classes, and types for all community members to share.

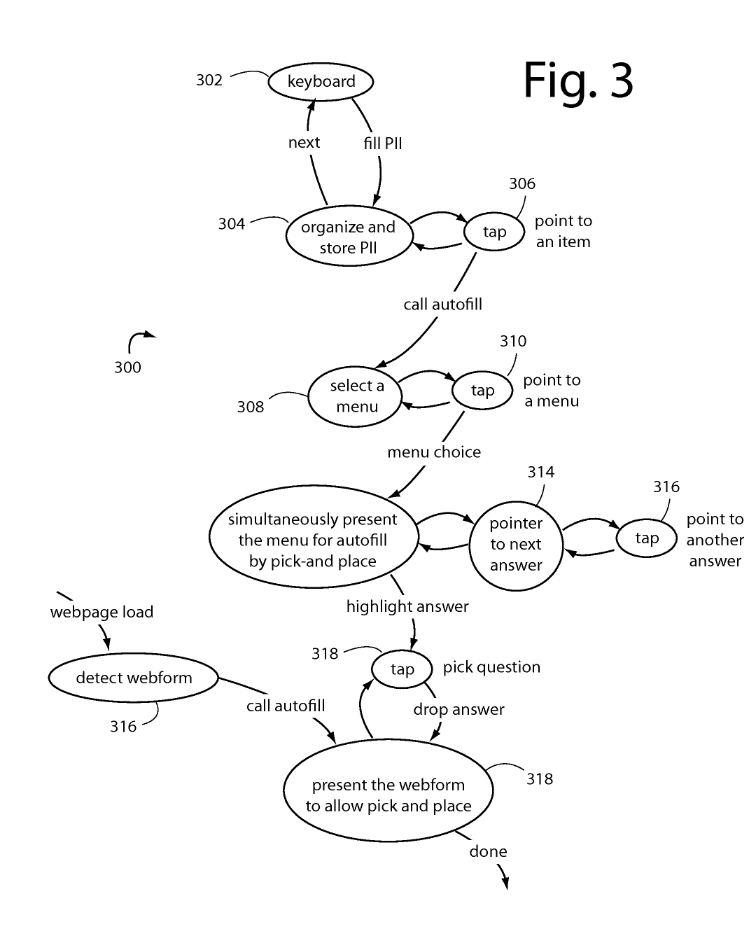

FIG. 3 represents a pick-and-place autofill method 300, in a embodiment of the present invention which is similar to that of FIG. 2. But here, the answers are automatically sequenced in a menu and the answer is dropped into the webform by screen tapping the corresponding question. The pick-and-place autofill method 300 has a process 302 to call a soft keyboard onto the touchscreen to fill in PII and other form data. Any data entry by the user is passed into a process 304 for organizing and storing PII in a local secure memory. A screen tap 306 allows any item in any menu to be selected for data entry, or a call to start an autofill assistant. A process 308 presents a line-up of the various menus available. A screen tap 310 is configured to select one such menu from many. A menu choice is sent to a process 312 that simultaneously presents the selected menu and its items on the touchscreen with a webform. A process 314 highlights or otherwise indicates to the user which answer item in the menu list is the “current answer”. A screen tap 316 allows the user to set any answer in the menu list to be the current answer.

A detect webform process 318 identifies webforms that may need autofill assistance when a webpage is loaded by the mobile device. The call for autofill may be automatic or invoked by screen tap 306. A process 320 presents the webform on the touchscreen simultaneously with the menu selected by screen tap 310. A screen tap 322 on the webform pulls the current question highlighted by process 312 and drops it in the webform as the user's answer. Screen tap 322 can be touched to end the autofill assistance and withdraw the menu.

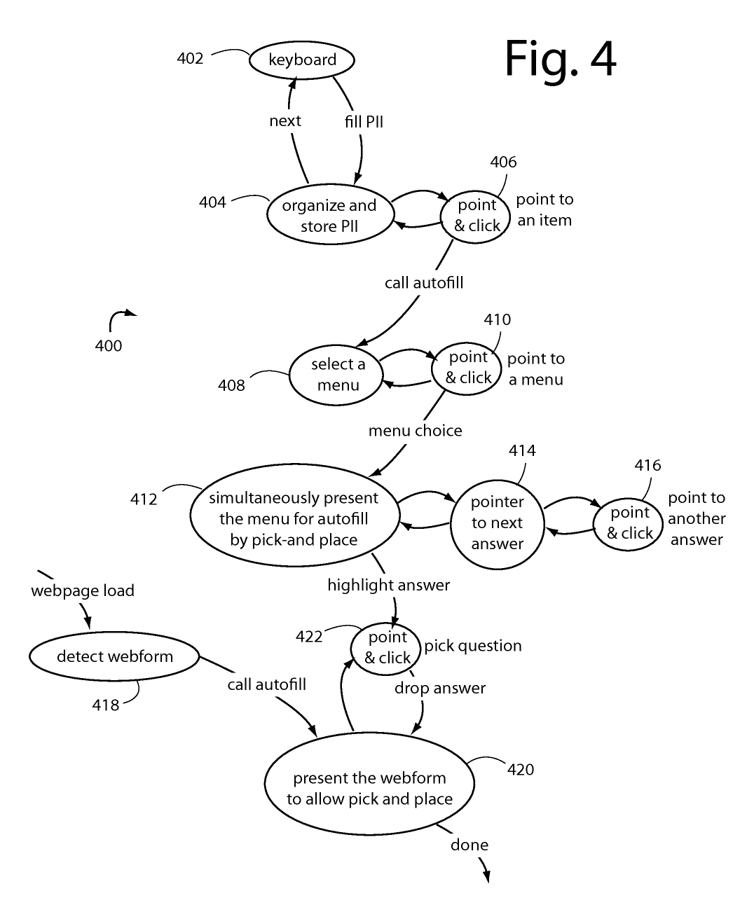

FIG. 4 illustrates an embodiment of the present invention that does not depend on a touchscreen. Instead of touching or tapping, a conventional mouse is used to point, click, drag, or drop. A laptop computer includes a standard mouse or touch pad and a conventional (non-touch) display screen.

FIG. 4 represents a pick-and-place autofill method 400 for a conventional laptop computer, in a embodiment of the present invention which is similar to that of FIG. 3 but does not require a touchscreen. As before, the answers are automatically sequenced in a drop down menu and the answer is dragged or dropped into the webform by mouse pointing and clicking the corresponding question.

The pick-and-place autofill method 400 has a step 402 to accept keyboard data entry to fill in PII and other form data. Any data entry by the user is passed into a step 404 for organizing and storing PII in a local secure memory. A mouse point and click 406 allows any item in any menu to be selected for data entry, or a call to start an autofill assistant. A step 408 presents a line-up of the various menus available. A mouse point and click 410 is configured to select one such menu from many. A menu choice is sent to a step 412 that simultaneously presents the selected menu and its items on the display screen with a webform. A step 414 highlights or otherwise indicates to the user which answer item in the menu list is the “current answer”. A mouse point and click 416 allows the user to set any answer in the menu list to be the current answer.

A detect webform step 418 identifies webforms that may need autofill assistance when a webpage is loaded by the laptop. The call for autofill may be automatic or invoked by mouse point and click 406. A step 420 presents the webform on the display screen simultaneously with the menu selected by mouse point and click 410. A mouse point and click 422 on the webform pulls the current menu item highlighted by process 412 and drops it in the webform as the user's answer. A mouse point and click 422 can be use to end the autofill assistance and withdraw the menu.

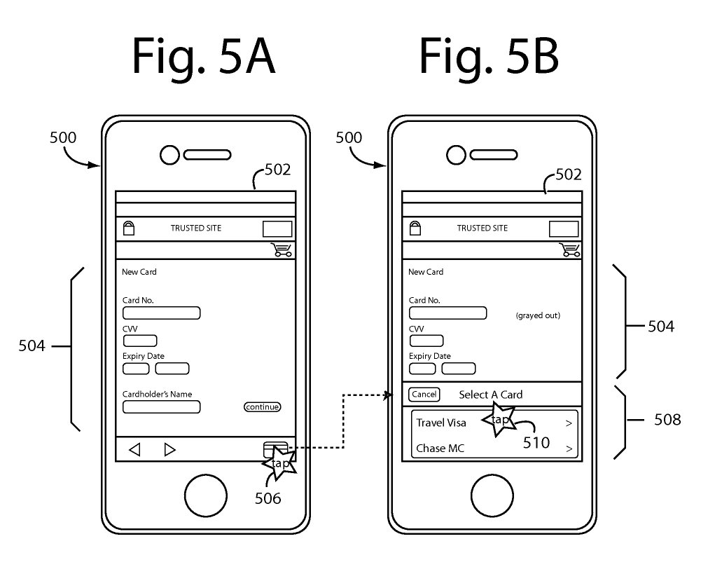

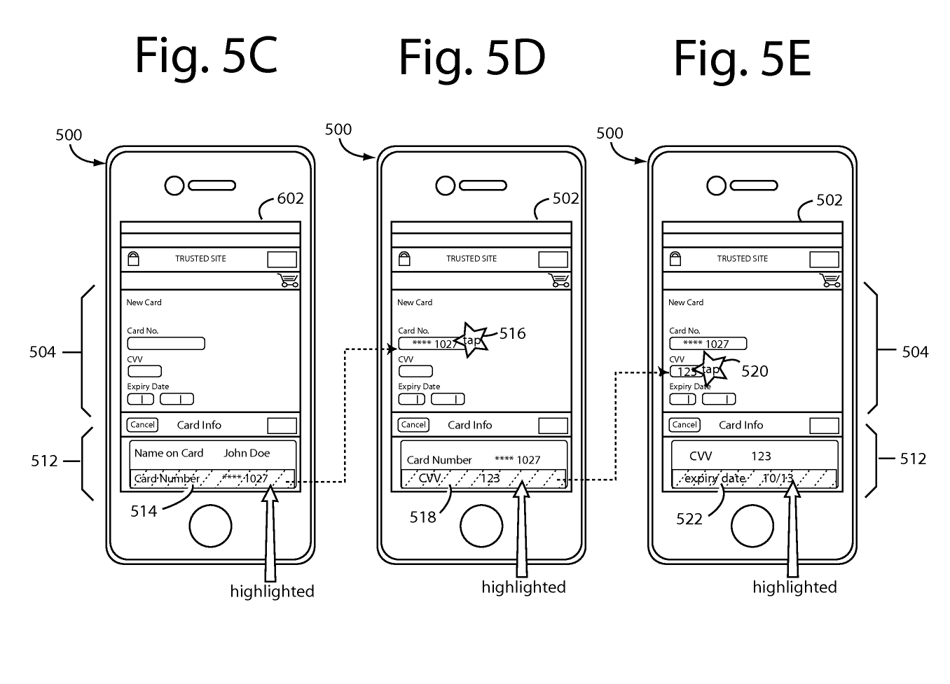

The action described for the pick-and-place autofill method 300 is partially illustrated in a time sequence, FIGS. 5A-5E. A conventional smartphone 500 uses the Google Android or Apple iOS operating system, and it includes and executes a downloadable pick-and-place auto fill app of the present invention. A touchscreen display 502 is shown in FIG. 5A after having navigated to a website shopping cart checkout. A webform 504 is presented that requests a number of responsive answers, if possible, these will be supplied by autofilling with locally stored PII. A screen tap 506 on a credit card icon causes a select-a-card menu 508 to be presented in FIG. 5B. A screen tap 510 selects a particular credit card the user has registered or used before and wants to use it for this checkout.

In FIG. 5C, a card info menu 512 is simultaneously displayed with the webform 504. A highlight 514 is placed on the card number item in the card info menu 512 to indicate to the user what “answer” will be dropped into the next question field they screen tap. In FIG. 5D, a screen tap 516 occurs over the card number question field in the webform 504. The answer is deposited, and a next highlight 518 advances to the CVV answer in card info menu 514. In FIG. 5E, a user has only to screen tap 520 over the CVV question field in webform 504. A next highlight 522 automatically advances to the expiry date answer in card info menu 514. The remaining steps should be obvious.

Here, the focus of the Description has been toward mobile devices with touchscreens. But embodiments of the present invention would certainly find useful applications in conventional personal computers with keyboards and mice pointing devices.

Although particular embodiments of the present invention have been described and illustrated, such is not intended to limit the invention. Modifications and changes will no doubt become apparent to those skilled in the art, and it is intended that the invention only be limited by the scope of the appended claims.

The invention claimed is:

1. An autofill system for a touchscreen and mobile device with access to webpages from websites over a wireless network and the Internet, comprising:
a webform configured to be displayed on a touchscreen of a mobile device and including a number of touch-selectable form fields posing questions requiring an answer of other response from a user;
an answer menu configured to be simultaneously displayed on said touchscreen and including a number of touch-selectable items that may be copied as responses to questions posed one-by-one by the webform metaphor;
a pick-and-place autofill app configured such that the touch-selectable form fields in the webform may be responded to with an answer from the answer menu by a screen tap on a particular touch-selectable item in a list, and automatically sequenced to a next touch-selectable form field in the webform, or that an automatically sequenced answer from the answer menu can be dropped into touch-selectable form fields in the webform with a corresponding screen tap.

2. The autofill system of claim 1, further comprising:
a form map configured for automatic webform mapping of those registered locally, or with a server that enables a community of users to share information related to particular form fills;
wherein, a number of fillable webforms with questions to answer have their constructions abstracted as a form map.

3. The autofill system of claim 1, further comprising:
a secure personally identifiable information (PII) database for storing and controlling access to data useful in constructing the answer menu, wherein such PII includes information repetitively accessed by a user to complete a checkout procedure with a shopping cart at an online webstore or a bank;
a community server configured to collect and distribute intelligence about how users have been filling out webforms on webpages on websites with their mobile devices; and
a wireless network controller configured for wireless Internet access;
wherein, the pick-and-place autofill app is configured to be downloaded and installed on the mobile device using a mobile app store such as Apple or Android through the wireless network controller;
wherein, a number of menus are organized into sets of answers from data obtained from the PII database or realtime touchscreen inputs from a user; and
wherein, a touchscreen controller simultaneously presents fillable webforms and selected menus with answer lists on a touchscreen 124.

4. A graphical user interface method for operating in a mobile device with a touchscreen for pointing and data entry, comprising:
organizing and storing personally identifiable user information (PII) configured to be presented as a series of selectable menus by touching an icon on a user touchscreen into a memory in said mobile device;
presenting a selected menu to allow a choice of touchable menu items configured to be answers to questions calculated to be posed by a fillable webform;
simultaneously displaying said fillable webform with a cursor, highlight, or other indication of a current question;
accepting any touch or tap on said fillable webform to advance said current question to a question displayed under such;
interpreting any touch or tap on said selected menu to reply to said current question with an answer displayed under such; and
advancing said current question to a question not yet answered or cycling around back to the beginning of the questions in said fillable webform;
wherein, answers from said menus are caused one-by-one to populate fields in said fillable webform strictly according to said current question being posed and a user selection of a menu item by touch or tap.

5. The method of claim 4, further comprising:
securing said PII in an encrypted memory vault within said memory in said mobile device and requiring at least security factor to allow access of it and a subsequent display in a touchscreen menu.

6. The method of claim 4, further comprising:
identifying and logging the organization and questions posed by said fillable webforms into a database such that predictive answers are thereafter made possible;
mapping which questions appear in what locations in each said fillable webform to enable automatic predictive answering.

7. The method of claim 6, further comprising:
checking to see if a current fillable webform being presented anew is one that has been previously identified, logged, and mapped; and
if so, using answers provided as local menu items to automatically and predicatively populate said fillable webform; and
displaying a populated fillable webform that results for user correction and approval by touch or tap.

8. The method of claim 4, further comprising:
identifying and logging the organization and questions posed by said fillable webforms;
mapping which questions appear in what locations in each said fillable webform to enable automatic predictive answering;
forwarding the identities, logs, and mappings, and without any PII, to a server database such that predictive answers are thereafter made possible in a community of users;
wherein, other mobile devices in said community are configured to see if a current fillable webform they are being presented with anew is one that has been previously identified, logged, and mapped into said server database; and
if so, using answers provided in each of their local menu items to privately, automatically, and predicatively populate said fillable webform; and
displaying a populated fillable webform that results for corresponding user correction and approval by touch or tap.

9. The method of claim 4, further comprising:
first time data entry of said PII by a user through said touchscreen into said memory in said mobile device; and
selecting a password configured to control access to said PII.

10. A graphical user interface (GUI) method for operating in a mobile device with a touchscreen for pointing and data entry, comprising:
presenting a webform with questions to answer on a touchscreen of a mobile device, wherein personally identifiable information (PII) is required;
indicating a current question to answer on a displayed part of said webform;
screen tapping to call a process for user selection of a menu of PII items related to a particular user;
screen tapping to select which menu to use thereafter in answering said questions and filling said webform;
simultaneously presenting a menu and its items list on the touchscreen with the webform;
configuring said touchscreen to allow said user to pick at random any menu item listed as an answer to said current question;
advancing said current question to a next question in said webform;
wherein, a series of screen taps on answers provided previously substantially reduces the PII data that must be entered over time into multiple webforms by a soft keyboard on said touchscreen.

11. The GUI method of claim 10, further comprising:
screen tapping to call a soft keyboard onto a touchscreen to enter or overwrite lists of items in said menus and maintained by a process for organizing and storing PII.

12. The GUI method of claim 10, further comprising:
loading webpages by the mobile device and screening to detect if a webform is present that needs autofill assistance;
if so, using a pick-and-place process to display the webform simultaneously with a menu selected by process;
configuring a screen tap to drop an answer picked at random from a list of items in the selected menu into a question box or form field in a webform pointed to;
wherein, once answered or otherwise responded to, advancing a highlight, cursor, pointer, or other kind of visual indicator to a next form field requiring a response.

13. The GUI method of claim 10, further comprising:
configuring a screen tap to jump at random to point to any form field tapped or touched by the user.

14. The GUI method of claim 10, further comprising:
tracking the class of menu items that a user indicates should go in particular form fields in a webform;
generating naming standards that consistently apply across-the-board to any form field encountered on any webpage and webform from any website; and
keeping descriptors that uniquely identify the form field labels, names, classes, and types such that accurate predictive auto-filling can proceed without significant errors or annoyances to the user the next time the same webform is loaded and requiring a response.
